(19) United States
(12) Patent Application Publication
(10) Pub. No.: US 2003/0204745 A1
(43) Pub. Date: Oct. 30, 2003

(54) Method and system for protecting a processing system from a buffer overflow attack

(75) Inventor: Roger Kenneth Abrams, Raleigh, NC (US)

Correspondence Address: IBM Corporation, Intellectual Property Law, MD 9CCA-B002/2, P.O. Box 12195, Research Triangle Park, NC, 27709, US

(73) Assignee: International Business Machines Corporation, Armonk, NY

(21) Appl. No.: 10/134,175

(22) Filed: Apr. 29, 2002

(51) Int. Cl. G06F 11/30; G06F 15/173

(52) U.S. Cl. 713/201; 711/163; 709/223

(57) ABSTRACT

A method and system for protecting a processing system from a buffer overflow attack are described. More particularly, embodiments of the present invention provide a plurality of local variables in a memory structure and provide a return address within the memory structure. The return address is at a lower address than the plurality of local variables to prevent the return address from being overwritten during a buffer overflow attack.

### FIELD OF THE INVENTION

The present invention relates to computer architecture, and more particularly to a method and system for protecting a processing system from a buffer overflow attack.

### BACKGROUND OF THE INVENTION

A computer system provides numerous services to users who have access to the computer system's resources. A computer typically has security measures to deny access from unauthorized users.

Buffer overflow attacks can be used by unauthorized users to gain access to the resources of a computer system. Buffer overflow attacks are the most common means of compromising a computer's security. The CERT® Coordination Center (CERT/CC), which is a computer security organization that tracks security problems, has stated that 50% of security compromises found have resulted from buffer overflow attacks (also referred to as stack smashing attacks).

FIG. 1 is a diagram of a plurality of conventional computer systems coupled to a network. A computer system 10 includes a central processing unit (CPU) 12 that is coupled to a storage unit 14, which includes a memory structure 16. The CPU 12 also couples to a printer 18, and a communication device 20. The communication device 20 enables the computer system 10 to interface with a network 22. External user units 24, 26, and 28, if authorized, can access the resources of the computer system 10 via the network 22. An external user that is unauthorized to access the resources of the computer system 10 may attempt to access it with a buffer overflow attack. The external user units 24, 26, and 28 can also be computer systems similar to the computer system 10. Accordingly, the external user units 24, 26, and 28 can also be subject to buffer overflow attacks. A buffer overflow attack is described below.

FIG. 2 is a block diagram of a conventional program stack 40, which is a part of the memory structure 16 of FIG. 1. Still referring to FIG. 2, the program stack 40 includes a return address 42, and as exemplary data, a function pointer 44, and a data buffer 46. The function pointer 44 and the data buffer 46 are referred to as local variables. Also shown are exemplary addresses 8070, 8080, 8090, 8096, and 8100. For clarity, the addresses are in decimal form. The data buffer 46 of this example is sized to hold 10 bytes. If data is copied into the data buffer 46 without the length of the copy being properly checked to assure that the data is 10 bytes or less, the data exceeding the 10 bytes will overflow the data buffer 46 and start overwriting other areas, such as the return address 42 and other potential stack-frame targets such as the function pointer 44. This is referred to as a buffer overflow. For example, an attacker (unauthorized external user) might send 30 bytes of data to the data buffer 46 with the last 4 bytes containing the address 8070. When the subroutine returns, the value in 42, which is 8070, would then be used as the new return address because the legitimate return address, which was in 42, has been overwritten. In addition, the data in the data buffer 46 can contain carefully crafted malicious executable code, which would then be executed. This executable code can allow an attacker to gain control of the computer, effectively penetrating the security of the computer system and accessing its resources. In the space of a few dozen instructions executed out of the buffer 46, the security of the computer system can be compromised.

In other circumstances, overwriting the function pointer 44 can be used to accomplish the same result, i.e., unauthorized access to a computer system. For optimization, the compiler of the computer system tends to place aligned data items close to the return address 42 and place unaligned items such as the data buffer 46 further away from the return address 42. This naturally places items useful to attack, such as function pointers, in harm's way.

The historical reason stacks were designed this way goes back to the time when CPUs were much simpler and memory sizes were severely limited. For example, a 64K machine might have run on a PC-DOS operating system (OS). The OS was loaded at the bottom of the memory. Next, the application code and data was loaded. The dynamic memory grew upward from there. The program stack started at the top of the memory and grew downward. This configuration made sense given the circumstances that the hardware environment imposed, in that the hardware was designed to work with this configuration. Specifically, the instructions that managed the stack, such as “push” and “pop” instructions, worked with the program stack starting at a high address and growing downward.

Generally, there is not a good solution to this problem today in that the known solutions are either expensive and unreliable or they affect performance.

One solution is for an experience computer programmer to perform a code audit. This includes carefully examining the source code for a program looking for the kinds of programming errors that make a buffer overflow possible. This work is difficult, expensive, and error prone. It also does not address the issue that new buffer overflow vulnerabilities may be introduced to the program in the future in the course of routine enhancements and maintenance.

Another solution is to modify the computer to place a guard variable on the stack next to the return address. The guard variable has a known value stored in it. Prior to using the return address, the guard variable is checked to see if it has been modified. If so, a buffer overflow is assumed and the program is aborted without using the corrupted return address. This is referred to as a stackguard™.

Disadvantages of the above-described solutions and other known arrangements include both the additional resources and the time required for performing the detection processes.

Accordingly, what is needed is a method and system for protecting a computer system from a buffer overflow attack. The system and method should be able to protect the return address of a program stack from such an attack. The present invention addresses such a need.

### SUMMARY OF THE INVENTION

The present invention achieves the above needs and others with a method and system for protecting a processing system from a buffer overflow attack. More particularly, embodiments of the present invention provide a plurality of local variables in a memory structure and provide a return address within the memory structure. The return address is at a lower address than the plurality of local variables to prevent the return address from being overwritten during a buffer overflow attack.

According to the method and system disclosed herein, the present invention renders a buffer overflow attack harmless. Accordingly, such an attack cannot allow an attacker to gain control of a computer system.

### BRIEF DESCRIPTION OF THE DRAWINGS

FIG. 1 is a diagram of a plurality of conventional computer systems coupled to a network;

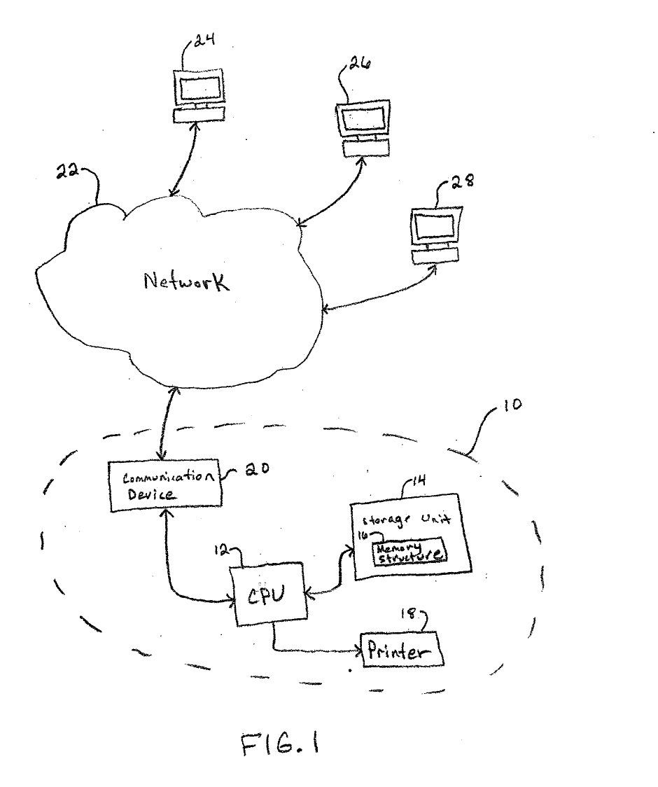

FIG. 2 is a block diagram of a conventional program stack, which is a part of the memory structure of FIG. 1;

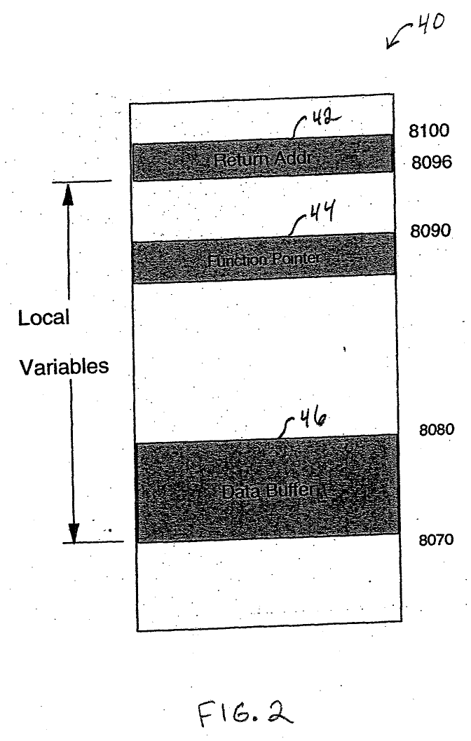

FIG. 3 is a diagram of a program stack in accordance with the present invention; and

FIG. 4 is a flow chart showing a method for protecting a computer system from a buffer overflow attack in accordance with the present invention.

### DETAILED DESCRIPTION

The present invention relates to computer architecture, and more particularly to a method and system for protecting a processing system from a buffer overflow attack. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

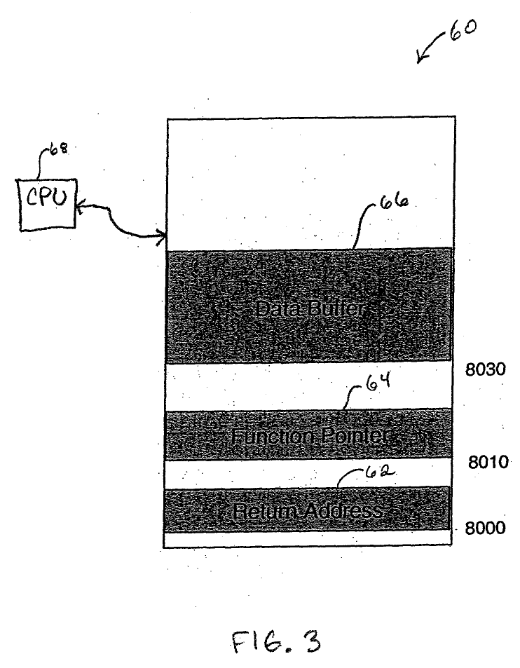

Generally, the present invention protects a processing system from a buffer overflow attack by placing a return address is at a lower address than a plurality of local variables. This prevents the return address from being overwritten during a buffer overflow attack. FIG. 3 describes an embodiment of the present invention.

FIG. 3 is a diagram of a program stack 60 in accordance with the present invention. The program stack 60 is designed to grow upward. Included are a return address 62, a function pointer 64, and a data buffer 66. The function pointer 64 and the data buffer 66 are local variables. Also shown are exemplary addresses 8000, 8010, and 8030. For clarity the addresses are in decimal form. A CPU 68 is coupled to the program stack 60.

The return address 62 is at a lower address than the data buffer 66. The function pointer 64 is below the data buffer 66, which is a normal optimization. Configured as such, when the data copy starts into the data buffer 66 at address 8030 the copy proceeds upward. If there is a buffer overflow, the targets, which an assailant needs to modify to gain control of the machine, are no longer available for overwriting. Because the program stack 60 is growing up and this is the executing subroutine, there are no stack-frame targets above the data buffer 66 to be overwritten. With large memories and memory management hardware that remap physical pages to virtual addresses, there is no disadvantage to building the program stack 60 this way.

The present invention applies to CPU designs that allow program stacks to grow up, and CPU designs that implement a dual-stack mode where a program stack can grow up or down, such as on a process-by-process basis.

In one embodiment of the present invention, the CPU instructions that manage the memory structure, or program stack, can determine if the program stack is growing upward or downward. The CPU instructions can properly perform their functions in either case.

In an embodiment of the present invention, a marker can be placed in a compiled executable code that informs the OS how the executable code was compiled so it can be executed properly. (Executable code for the two modes will differ, particularly regarding offsets to local variables in the stack frame.) A runtime dynamic link library (DLL) may require two versions to support both stack modes. Alternatively, a DLL can have two versions of affected entry points in it with a predictable change in the name so the correct one can be selected. For example, a “down stack” entry point can have one underscore preceding the name, and the corresponding “up stack” entry point can have two underscores preceding the name. A CPU can manage the program stack in dual mode on a process-by-process basis to provide a migration path. The migration path allows existing binaries to run unchanged. In addition, the OS and networking code, which are particularly vulnerable, can be quickly recompiled.

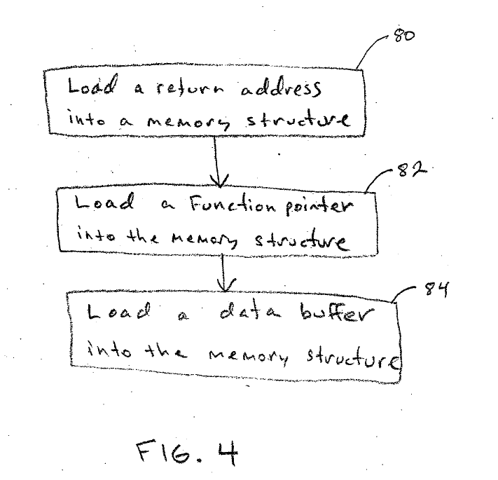

FIG. 4 is a flow chart showing a method for protecting a computer system from a buffer overflow attack in accordance with the present invention. A program stack is built upward from a lower address to a higher address. In a first step 80, a return address is loaded into the program stack. In a second step 82, other local variables, such as a function pointer, are loaded. The local variables are loaded after the return address is loaded. The local variables are also loaded at higher addresses than the return address. Other potential stack-frame targets be protected from a buffer overflow attack are also loaded after the return address and at higher addresses than the return address. In a final step 84, a data buffer is loaded at a higher address than the return address and the other local variables. In some specific embodiments, the order of the local variables, other than the data buffer, will vary and the order will depend on the specific application.

According to the present invention, the data buffer is loaded last and is placed at a higher address than the return address, the other local variables, and any other potential stack-frame targets, to protect these potential targets from being overwritten during a buffer overflow attack. This protects these potential targets, because they are at a lower address than the data buffer and thus cannot be overwritten during a buffer overflow attack. This renders a buffer overflow attack harmless.

According to the method and system disclosed herein, the present invention provides numerous benefits. For example, it renders a buffer overflow attack harmless, because a buffer overflow attack would not affect the return address and other potential stack-frame targets. Accordingly, such an attack cannot allow an attacker to gain control of the computer system implementing the present invention. If an attacker cannot gain control of the computer system, a buffer overflow attack is no longer a dangerous threat and is at most, a mere nuisance.

Although the present invention has been described in accordance with the embodiments shown, one of ordinary skill in the art will readily recognize that there can be variations to the embodiments and those variations would be within the spirit and scope of the present invention. Accordingly, many modifications may be made by one of ordinary skill in the art without departing from the spirit and scope of the appended claims.

What is claimed is:

1. A memory structure comprising:
a plurality of local variables; and
a return address, the return address being at a lower address than the plurality of local variables to prevent the return address from being overwritten during a buffer overflow attack.

2. The memory structure of claim 1 wherein the plurality of local variables includes a data buffer, and wherein any other local variable of the plurality of local variables is at a lower address than the data buffer to prevent the any other local variable from being overwritten during a buffer overflow attack.

3. The memory structure of claim 2 wherein the plurality of local variables includes a function pointer.

4. A system for protecting a processing system from a buffer overflow attack, the system comprising:
a central processing unit (CPU); and
a memory structure coupled to the CPU, the memory structure including:
a plurality of local variables; and
a return address, the return address being at a lower address than the plurality of local variables to prevent the return address from being overwritten during a buffer overflow attack.

5. The system of claim 4 wherein the plurality of local variables includes a data buffer, and wherein any other local variable of the plurality of local variables is at a lower address than the data buffer to prevent the any other local variable from being overwritten during a buffer overflow attack.

6. The system of claim 5 wherein the plurality of local variables includes a function pointer.

7. The system of claim 4 wherein the CPU can implement a dual-stack mode where the memory structure can grow upward or downward.

8. The system of claim 7 wherein the CPU instructions that manage the memory structure can determine if the memory structure is growing upward or downward, and wherein the CPU instructions can properly perform their functions in either case.

9. A method for protecting a processing system from a buffer overflow attack, the method comprising the steps of:
(a) providing a plurality of local variables within a memory structure; and
(b) providing a return address within the memory structure, the return address being at a lower address than the plurality of local variables to prevent the return address from being overwritten during a buffer overflow attack.

10. The method of claim 9 wherein the providing step (b) further comprises the step of (b1) providing a data buffer within the memory structure, wherein any other local variable of the plurality of local variables is at a lower address than the data buffer to prevent the any other local variable from being overwritten during a buffer overflow attack.

11. The method of claim 10 wherein the providing step (b) further comprises the step of (b2) providing a function pointer within the memory structure.

12. A method for protecting a memory structure from a buffer overflow attack, the method comprising the steps of:
(a) loading a return address into the memory structure; and
(b) loading a plurality of local variables into the memory structure, the return address being at a lower address than the plurality of local variables to prevent the return address from being overwritten during a buffer overflow attack.

13. The method of claim 12 wherein the loading step (b) further comprises the step of (b1) loading a data buffer into the memory structure, the data buffer being at a higher address than any other local variable of the plurality of local variables to prevent the any other local variable from being overwritten during a buffer overflow attack.

14. The method of claim 13 wherein the loading step (b) further comprises the step of (b2) loading a function pointer into the memory structure.

15. A computer-readable medium including program instructions for protecting a processing system from a buffer overflow attack, the program instructions for:
(a) providing a plurality of local variables within a memory structure; and
(b) providing a return address within the memory structure, the return address being at a lower address than the plurality of local variables to prevent the return address from being overwritten during a buffer overflow attack.

16. A computer-readable medium including program instructions for protecting a processing system from a buffer overflow attack, the program instructions for:
(a) loading a return address into the memory structure; and
(b) loading a plurality of local variables into the memory structure, the return address being at a lower address than the plurality of local variables to prevent the return address from being overwritten during a buffer overflow attack.

17. A system for protecting a processing system from a buffer overflow attack, the system comprising:
a central processing unit (CPU) that can implement a dual-stack mode where the memory structure can grow upward or downward; and
a memory structure coupled to the CPU, the memory structure including:
a plurality of local variables, wherein the plurality of local variables includes a data buffer, wherein any other local variable of the plurality of local variables is at a lower address than the data buffer to prevent the any other local variable from being overwritten during a buffer overflow attack; and
a return address, the return address being at a lower address than the plurality of local variables to prevent the return address from being overwritten during a buffer overflow attack.
